(19) United States
(12) Patent Application Publication
(10) Pub. No.: US 2025/0278808 A1
(43) Pub. Date: Sep. 4, 2025

(54) Trade Policy: Evidence Based Trade Policy for the United States of America and the World - Blockchain a new Service Industry

(71) Applicant: Paresh B. Fozdar, Elmhurst, NY (US)

(72) Inventor: Paresh B. Fozdar, Elmhurst, NY (US)

(21) Appl. No.: 18/165,966

(22) Filed: Feb. 8, 2023

(51) Int. Cl. G06Q 50/26

(52) U.S. Cl. CPC G06Q 50/265

(57) ABSTRACT

Evidence Based Trade Policy for the United States of America and the World to make Blockchain a new Service Industry. Improvise and Safeguard Human health and Wealth against harm by elevated Trust, Security and Authenticity in the system and Consumer-focus approach to auto-disrupt any industry monopoly. Allows trade simplification to elevate industrial productivity and economy by adoption of Self-Selection Hypothesis by established industries that are utilizing Blockchain with proven success and Learning Hypothesis by remainder industries to increase efficiency by Blockchain transition. Continuous innovation for Blockchain Service Industry by each country worldwide to create a Trade in Value-Added contribution towards its local Blockchain Service Industry, leads to a global Blockchain Service Industry

### POLICY

Blockchain Service, a new service industry for worldwide Trade

### NEED

Human Health and Wealth is recognized by Paper and Digital records
These records require Trust, Security, sad Authenticity
Cannot be compromised by fraud and stealing

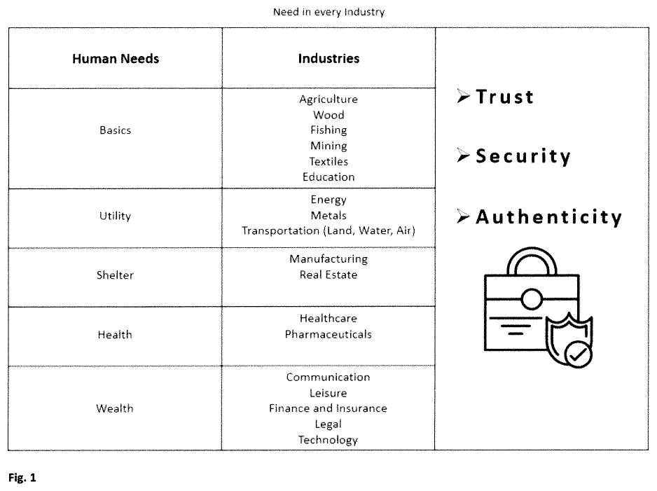

Refer to FIG. 1

### OUTLINE

Blockchain technology has the ability to store and safeguard Human Health and Wealth information; offering complete: control
Ability of Blockchain to service every Trade industry, requires that it should be defined as a new service industry worldwide

### Blockchain

Chain of secure storage blocks, referencing each other through codes

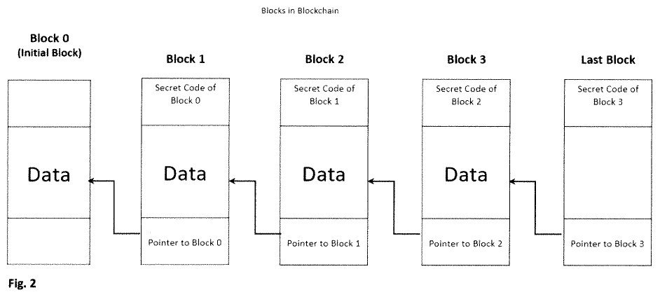

Refer to FIG. 2
Each block in the chain, has records or data or content
Each block has Secret code to previous and next block
Each block maintains its order and connectivity in the chain
The chain of blocks forms a ledger (that is, a Book of records)
Ledger is auto-guarded in a Private vault

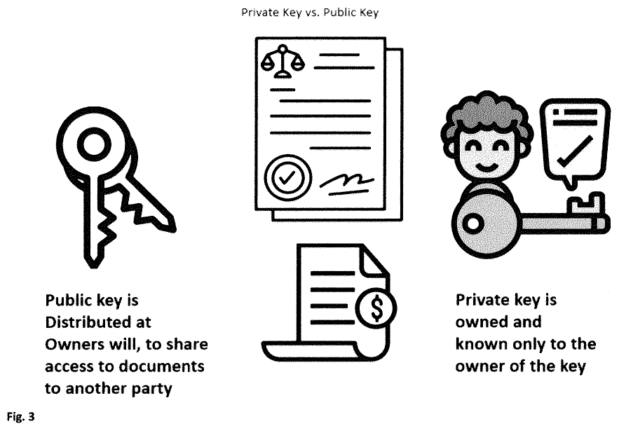

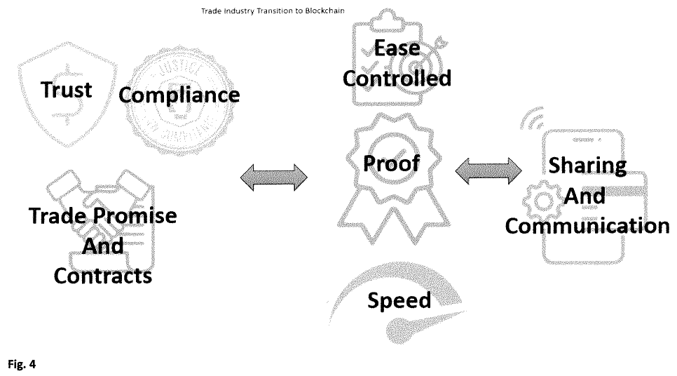

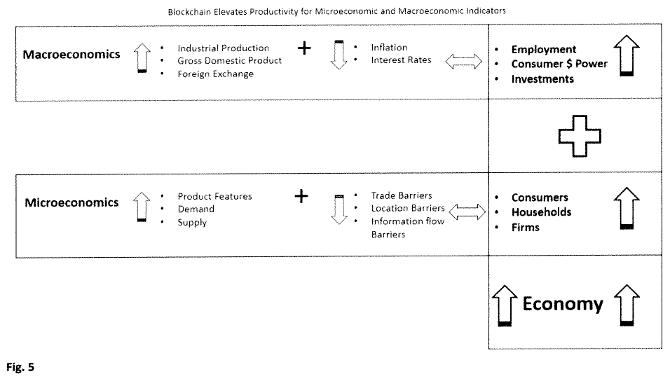

Refer to FIG. 3
Vault is Tamper-Proof (cannot be altered)
Guarded and Secure with keys (private and/or public)
Private of original copy retention
Public key is used for sharing information with 3rd parties, if needed and can be revoked at any time

### Transition of Trade Industries

Every Trade Industry has and will find use of Blockchain service industry for the reasons below:
Openness of Economy increased
Trade Documentary Compliance, easily executed
Trade Promises and Contracts can be stored between Regions, Bilaterally, Multilateral
Controlled and Secure information Storage
Ease and Speed of Sharing
Ownership proof and control
Trust and Authenticity
Information Cannot be Compromised or Altered

### Adoption as a Ripple-Effect

Encourages Openness of Economy, in every industry, for the reasons below:

Reduced Tariffs

Transparent identifiable Trade Quota
Additional transparency for NTB (Non-Tariff-Barriers)
FDI (Foreign Direct Investment) and M&A increases due to transparency
Attractive for Portfolio Investment and Greenfield
Aligns with Sustainable Development Goals (SDGs) in emerging countries

### Productivity Elevated

At Macroeconomic-level, growth increases as markets perform better, knowledge sharing eases
At Microeconomic-level, ease doing business in foreign markets, with international knowledge exposure
Blockchain Service Industry Aligns with Modern trade theories
Economic support during Globalization or De-Globalization phases

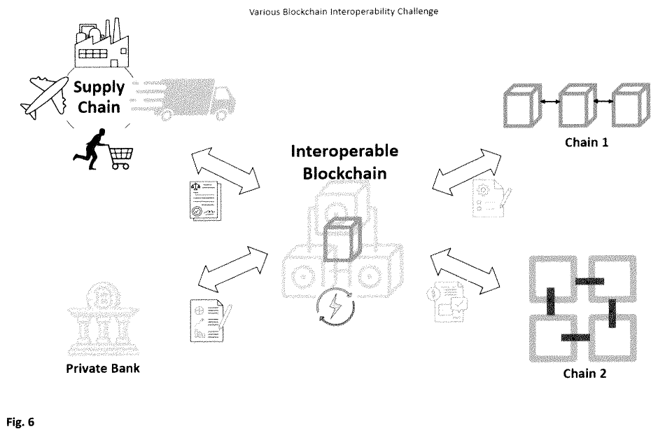

Refer to FIG. 5

### Trade Policy Simplified

Negotiations and treaties, executed, faster identification of its ill side-effects, if any
Tariff, Subsidies, Quotas, can better controlled, managed, broadcasted
Economic Diplomacy for state, culture, political reasons better communicated

### Proven Use Cases by Industry

### Goods and Services

Buyers or Sellers to transfer reputation using distributed ledger, overcome Trust Challenges

### Supply-chain/Logistics

Increase transparency of productions and distributions chains in regional or bi-or multilateral Economies especially for perishable produce, livestock products

### Art and Recreation

Drive content trading between producers and buyers
Facilitates FDI and ideas
Improved transparency on sharing rights, licensing terms
Examples are Art or Film creators and distributors

### Energy

Decentralized energy data exchange platforms
Enable Forecasting for investment and trade of Smart-Grids

### Healthcare

Personal health records better guarded
Patient can sell their data to his/her consented drug-trial

### Finance and Insurance

Facilitates large dollar value transactions, with history records, e.g.: Real-Estate transactions
Safeguard title records and documents
Accounting allows continuous verification, very low threat of alteration/corruption
Middle and Back office operations highly transparent e.g.: payroll, underwriting, reconciliations and many others

### Legal

Court trials eased with no compromised documents in transit
No written contracts, less expensive lawyer involvement
Secure property, intellect property, and replace public notary

### Entertainment

Avoids duplicate ticketing frauds e.g.: for large sports events

### Hardships Identified

Trade data availability for analysis, will require permissions and will not always be publicly or privately available
Blockchain Fraud references were due to its popularity or association with, immature cryptocurrency investments
Policy Makers need to spend more time on the Recognition and Interoperability of various Blockchain

### Evidence and Extension

A Self-Selection Hypothesis is applied by industries like Banking, Financial Services, Government; Healthcare, Oil and gas, at various levels
Learning Hypothesis can be applied to more industries. The transition cannot be instant, however some industries can adapt more readily
Blockchain service industry disrupts monopoly and gives more power to Consumers
Blockchain has proven its success, across various industries
Ability to safeguard Human health and Wealth Every country, worldwide, can create Trade in Value Added Contribution towards its Blockchain Service Industry

### Policy Inference

Blockchain Service industry, should be established worldwide

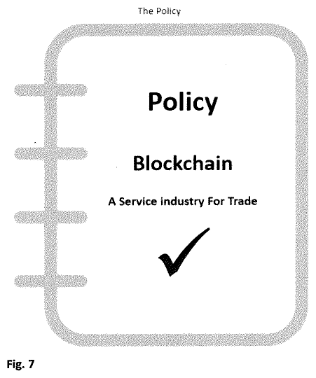

Refer to FIG. 7

1. Improvise and Safeguard Human health and Wealth against harm
a. Elevated Trust, Security and Authenticity in the system
b. Consumer focus approach to auto-disrupt any industry monopoly

2. Trade simplification to elevate industrial productivity and economy by adoption of:
a. Self-Selection Hypothesis by established industries that are utilizing Blockchain with proven success
b. Learning Hypothesis by remainder industries to increase efficiency by Blockchain transition

3. Continuous innovation for Blockchain Service Industry by each country worldwide to create a Trade in Value-Added contribution towards its local Blockchain Service Industry, leads to a global Blockchain Service Industry
